(19) United States
(12) Patent Application Publication
(10) Pub. No.: US 2025/0087952 A1
(43) Pub. Date: Mar. 13, 2025

(54) METHOD, SYSTEM, AND ADAPTER FOR ENABLING AN ETHERNET CABLE CONNECTION FOR A SMARTPHONE

(71) Applicant: Ali Khan, New York, NY (US)

(72) Inventor: Ali Khan, New York, NY (US)

(21) Appl. No.: 18/828,643

(22) Filed: Sep. 9, 2024

Related U.S. Application Data
(60) Provisional application No. 63/537,493, filed on Sep. 9, 2023.

(51) Int. Cl. H01R 31/06

(52) U.S. Cl. CPC H01R 31/06

(57) ABSTRACT

A method, system, and ethernet cable adapter for providing a hardline network interface connection for all smart devices is provided. The method, system, and ethernet cable adapter enables a hardline ethernet connection for a smart device including an electrical connection formed between a non-hardline ethernet connection and a hub, wherein the hub provides a hardline ethernet connection.

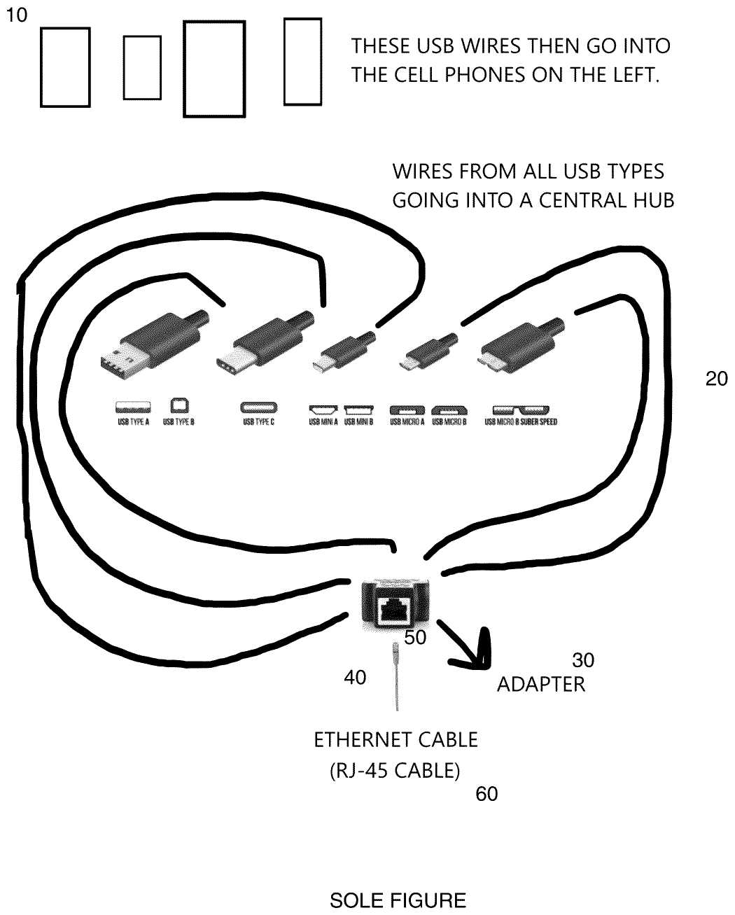

### CROSS-REFERENCE TO RELATED APPLICATION

This application claims the benefit of priority of U.S. provisional application No. 63/537,493, U.S. provisional application number filed 9 Sep. 2023, the contents of which are herein incorporated by reference.

### BACKGROUND OF THE INVENTION

The present invention relates to modular connector systems and, more particularly, to a method, system, and ethernet cable adapter for providing a hardline network interface connection for all smart devices.

There are connectors for smartphones which allow them to do various things and connect to different kinds of devices, like computers and chargers, but none which enable a connection between the smart device to an ethernet cable.

Currently there is no way to connect smart devices to an ethernet cable wire or, to be more specific, an RJ45 wire, which would enable hardline internet access currently afforded to PCs, fax machines, printers and/or any other hardware devices. In other words, there is currently no hardware that offers the functionality of connecting any smartphone to an ethernet cable or RJ45 cable.

As can be seen, there is a need for a solution that enables any smart device to connect to an ethernet cable, thereby providing it with a hardline network interface connection.

### SUMMARY OF THE INVENTION

The present invention would provide smartphones with the ability to have hardline internet connections instead of relying on their wireless internet connections. Furthermore, it could also connect them (with a hardline connection) to many other devices and networks.

In one aspect of the present invention, an electrical connection formed between a non-hardline ethernet connection and a hub, wherein the hub provides a hardline ethernet connection by way of a modular connection wire, and wherein the modular connection wire is configured to operatively associate with a port of at least one of the following: USB-A, USB-C, USB-B, USB-Mini, USB-Micro, USB-C, or lightning port.

These and other features, aspects and advantages of the present invention will become better understood with reference to the following drawings, description and claims.

### BRIEF DESCRIPTION OF THE DRAWINGS

The sole figure is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a method, system, and ethernet cable adapter for providing a hardline network interface connection for all smart devices.

Referring to the sole figure the present invention may include a method providing the following steps/components:
Component 1: providing modular connector wires 20 for the following connections: USB-A, USB-C, USB-B, USB-Mini, USB-Micro, USB-C, or lightning cable ports.
Component 2: connecting said modular connector wires 20 to a central connector or hub 40, which allows passthrough signaling and communications for all these connections to an ethernet cable or RJ45 cable 60.
Component 3: providing an input connector 50 for an ethernet cable or RJ45 cable 60.

The relationship between the components is as follows. The (USB-A, USB-C, USB-B, USB-Mini, USB-Micro, USB-C, and/or lightning cable) modular connector wires 20 are an output of the invention and are configured to provide two-way communications whereby data and other information can go to and from the computing devices/smartphones 10 through these outputs/modular connector wires 20. For the smartphones 10 these would be considered inputs, as they would be plugged into the modular connector wires 20. These modular connector wires 20 are then connected to an ethernet cable or RJ45 cable 60 via hub 30 and/or adapter 30. The ethernet cable enables smartphones 10 to connect to the internet and/or other devices and networks using this hardline connection. The ethernet cable 60 is connected to other devices and/or network devices which then are connected to the internet or any other network interface, including but not limited to private networks, secure networks, encrypted networks, government networks, etc.

By following the above-listed steps in the order listed, a user can create an adapter or connector to connect any smartphone 10 to an ethernet cable or RJ45 cable 60. The basic steps and idea of the invention is to take the input of smartphones 10 (via USB-A, USB-C, USB-B, USB-Mini, USB-Micro, USB-C, or lightning cable) which have two-way signal and information functionality, whereby data and signals can go to smartphones 10 and out of them through these connections 20, and connect them to a hub 40 with an input for an ethernet cable or an RJ45 cable 60. Conceptually, it is an adapter 30 that can be plugged into any smartphone 10 on one end and the other end is electrically coupled to an ethernet cable 60.

The modular connector wires 20 which connect to the mobile computing devices/phones 10 (via USB-A, USB-C, USB-B, USB-Mini, USB-Micro, USB-C, lightning ports) are the inputs for the smart phones 10. However, they also act as outputs because the modular connector wires 20 can send and receive signals. The modular connector wires 20 are used so that one adapter 30 can be used instead of making a separate one for each individual type of connection. They then connect to the central hub 40 which contains a connector for an ethernet cable or RJ45 cable 60. The present invention provides wires connecting the smart phones to a hub which contains an input for a connector for an ethernet cable or RJ45 cable 60. The smartphones can now connect to an ethernet cable 60, which in turn is connected to other devices and/or networks. This provides a direct, hardline internet connection for these smartphones 10, so they do not have to rely on wireless data and internet connections.

The components could be shuffled around by changing the order of the wires going into the smartphone 10. For example, they could be put in a different order than the one listed, but the result would still be the same; they would be providing the functionality of connecting a smartphone 10 to the ethernet cable or RJ45 cable 60. The present invention can be improved upon by providing a hard case that would provide support the input into the smartphone and not let the weight of ethernet cable pull out or loosen the connection of the wire going into the phone if one was to walk around with the ethernet cable 60 plugged in. One could make the invention simpler and easier by making an individual adapter for each type of connection (USB-A, USB-C, USB-B, USB-Mini, USB-Micro, USB-C, or lightning ports). One could make the modular connector wires 20 for all the connections extremely long so that all of the connections (USB-A, USB-C, USB-B, USB-Mini, USB-Micro, USB-C, or lightning ports) could be connected to a device and they in turn could all utilize that one ethernet cable or RJ45 cable 60 for a hardline connection to the internet, another device(s) and/or networks.

Additionally, the present invention can create adapters for any kind of devices which use (USB-A, USB-C, USB-B, USB-Mini, USB-Micro, USB-C, or lightning port) connections enabling a hardline connection with an ethernet cable or RJ45 cable 60. It can create new modems which can give hardline internet access to smartphones. Any future connection types to smartphones and/or other devices which connect directly to an ethernet cable or RJ45 cable are contemplated by the present invention. Any kind of modem and/or hub which will have the ability to accept any of the following connections (USB-A, USB-C, USB-B, USB-Mini, USB-Micro, USB-C, or lightning ports) and has inputs for an ethernet cable or RJ45 cable 60 is contemplated by the present invention. Any kind of modem and/or hub with one or any of the following connections (USB-A, USB-C, USB-B, USB-Mini, USB-Micro, USB-C, or lightning cable ports) and that also has an input for an ethernet cable or RJ45 cable 60 is protected. This type of invention can be used in the automotive industry, avionics industry, schools, universities, government facilities, secure government facilities, private networks, SCIFs (Secure Compartmentalized Information Facilities), jails, prisons, apartment buildings, corporate buildings, offices, laboratories, and factories.

The present invention can create adapters for any kind of devices which use USB-A, USB-C, USB-B, USB-Mini, USB-Micro, USB-C, lightning connections to have a hardline connection with an ethernet cable or RJ45 cable. It can create new modems which could give hardline internet access to smartphones.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system for enabling a hardline ethernet connection for a smart device:
an electrical connection formed between a non-hardline ethernet connection and a hub, wherein the hub provides a hardline ethernet connection by way of a modular connection wire, and wherein the modular connection wire is configured to operatively associate with a port selected from the group consisting of USB-A, USB-C, USB-B, USB-Mini, USB-Micro, USB-C, or lightning port.
